(19) United States
(12) Patent Application Publication
(10) Pub. No.: US 2014/0104997 A1
(43) Pub. Date: Apr. 17, 2014

(54) MAGNETIC RECORDING MEDIUM, METHOD FOR MANUFACTURING MAGNETIC RECORDING MEDIUM, AND MAGNETIC RECORDING AND REPRODUCING DEVICE

(71) Applicants: SHOWA DENKO K.K., Tokyo (JP); TOHOKU UNIVERSITY, Sendai-shi (JP); KABUSHIKI KAISHA TOSHIBA, Tokyo (JP)

(72) Inventors: Hisato SHIBATA, Higashine-shi (JP); Ken INOUE, Ichihara-shi (JP); Tsubasa OKADA, Ichihara-shi (JP); Gohei KUROKAWA, Ichihara-shi (JP); Shin SAITO, Sendai-shi (JP); Shintaro HINATA, Sendai-shi (JP); Migaku TAKAHASHI, Sendai-shi (JP); Tomoyuki MAEDA, Kawasaki-shi (JP); Yosuke ISOWAKI, Yokohama-shi (JP); Akira KIKITSU, Yokohama-shi (JP)

(73) Assignees: SHOWA DENKO K.K., Tokyo (JP); TOHOKU UNIVERSITY, Sendai-shi (JP); KABUSHIKI KAISHA TOSHIBA, Tokyo (JP)

(21) Appl. No.: 14/051,005

(22) Filed: Oct. 10, 2013

(30) Foreign Application Priority Data
Oct. 11, 2012 (JP) 2012-226345

(51) Int. Cl. G11B 5/738

(52) U.S. Cl. CPC G11B 5/738
USPC 369/13.33; 360/86; 428/831; 428/831.2; 204/192.15

(57) ABSTRACT

A magnetic recording medium is disclosed in which, on a non-magnetic substrate 1, at least an orientation control layer that controls orientation of a layer immediately above and a vertical magnetic layer in which an easy axis of magnetization is mainly vertically oriented with respect to the non-magnetic substrate are laminated. The orientation control layer includes an Ru-containing layer containing Ru or Ru alloy, and a diffusion prevention layer provided on the Ru-containing layer on the side of the vertical magnetic layer, is made of a material having a melting point of 1500° C. or higher and 4215° C. or lower and formed by a covalent bond or an ionic bond, and prevents thermal diffusion of Ru atoms of the Ru-containing layer. The vertical magnetic layer has a crystalline structure of crystal grains continuously formed from the Ru-containing layer with the diffusion prevention layer interposed therebetween, and includes a columnar crystal continuously formed in a thickness direction together with the crystal grains.

### BACKGROUND OF THE INVENTION

1. Field of the Invention

The present invention relates to a magnetic recording medium, a method for manufacturing the magnetic recording medium, and a magnetic recording and reproducing device.

Priority is claimed on Japanese Patent Application No. 2012-226345, filed on Oct. 11, 2012, the content of which is incorporated herein by reference.

2. Description of Related Art

Hard disk drives (HDDs) as magnetic recording and reproducing devices have shown a recording density increase rate of 50% or greater per year, and such a rate is expected to continue. Accordingly, a magnetic head and magnetic recording medium suitable for high-density recording have been developed.

In a magnetic recording and reproducing device, a vertical magnetic recording medium provides an easy axis of magnetization for a magnetic film that is vertically oriented and is mounted as a magnetic recording medium. The vertical magnetic recording medium is not influenced to a significant degree by the demagnetizing field in a boundary region between recording bits even in the case of high-density recording to form a definite bit boundary, and thus, noise increase is suppressed. In addition, the vertical magnetic recording medium is excellent in thermal fluctuation characteristics since reduction of a recording bit volume according to high-density recording is small.

Further, the use of a single-pole head having an excellent writing ability with respect to a vertical magnetic layer has been studied to cope with the demand on higher recording density of the magnetic recording medium. Specifically, a magnetic recording medium has been proposed in which a layer made of a soft magnetic material, called a protective layer, is provided between a vertical magnetic layer that is a recording layer and a non-magnetic substrate to enhance an entrance and exit efficiency of a magnetic flux between a single-pole head and the magnetic recording medium.

Further, as a technique that enhances a recording and reproducing characteristic and a thermal fluctuation characteristic of a magnetic recording medium, a magnetic recording medium including a soft magnetic underlayer, an orientation control layer, and a vertical magnetic layer that includes a lower magnetic layer including magnetic grains of a columnar structure and an upper layer including magnetic grains epitaxially grown from crystal grains of the lower magnetic layer has been proposed (see JP-A-2004-310910, for example).

Further, a technique has been proposed in which an intermediate layer in which metal grains made of Ru are protruded from a non-magnetic base material is provided between a soft magnetic protective layer and a recording layer to facilitate a separated structure in a magnetic layer and to uniformly isolate crystal grains in the recording layer (see JP-A-2007-272990, for example).

Further, a technique has been proposed in which, in a vertical magnetic recording medium in which a non-magnetic substrate, an underlayer and a magnetic layer are sequentially laminated, an initial layer part of two underlayers made of Ru is formed at a low gas pressure and a front surface layer thereof is formed at a gas pressure higher than that of the initial layer part (see JP-A-2004-22138, for example).

Further, JP-A-2011-216141 discloses a technique in which an auxiliary recording layer that includes a CoCrPtRu alloy as a main component is formed above a granular magnetic layer to complement disturbance of crystals at an initial growth stage of the auxiliary recording layer and a substrate on which the auxiliary recording layer is formed is heated to improve crystallinity of the auxiliary recording layer.

Further, a technique that uses a thermally-assisted recording method as a next-generation recording method capable of realizing high-density recording has been proposed. For example, JP-A-11-353648 discloses an information recording medium on which recording and reproduction of information is performed using a magnetic field or light. In the thermally-assisted recording method, a coercive force may be considerably reduced by heating a magnetic recording medium, and thus, a fine magnetic grain diameter may be achieved while maintaining thermal stability. Thus, it is possible to achieve a surface density of a level of 1 Tbit/inch².

### SUMMARY OF THE INVENTION

The present invention provides a recording density higher than that of the related art. In order to realize HDD high-density recording, it is necessary to improve a vertical magnetic layer provided in a magnetic recording medium. Specifically, it is necessary to increase vertical orientation of a vertical magnetic layer and to enhance crystallinity of the vertical magnetic layer compared with the related art.

An object of the invention provides a magnetic recording medium suitable for high-density recording of an HDD, including a vertical magnetic layer having excellent vertical orientation and crystallinity, and a manufacturing method thereof.

Another object of the invention provides a magnetic recording and reproducing device that includes the magnetic recording medium and is capable of realizing higher recording density.

As mentioned above, in order to realize a magnetic recording medium suitable for an HDD of a recording density higher than that of the related art techniques, it is necessary to further improve a vertical magnetic layer that forms the magnetic recording medium. As a method of improving the vertical magnetic layer, a method that includes a heating process of heating a substrate at a predetermined temperature immediately before the start of formation of the vertical magnetic layer and/or during the formation may be considered.

Specifically, for example, by performing a heating process of heating a substrate at a predetermined temperature immediately before the start of formation of the vertical magnetic layer and/or during the formation, it is possible to obtain a vertical magnetic layer having excellent crystallinity.

Further, for example, in a magnetic recording medium of a thermally-assisted recording method that is expected as a next-generation recording method, in a case where a vertical magnetic layer made of a FePt-based magnetic layer is formed, the formation is performed as follows. That is, by performing a heating process of heating a substrate at a temperature that is equal to or higher than an ordering temperature of an FePt phase (phase transformation temperature from a disordered phase (fcc) to an ordered phase (fct)) immediately before the start of formation of the vertical magnetic layer and/or during the formation, it is possible to transform the phase of the FePt-based magnetic layer.

However, according to review of the present inventors, in a case where an orientation control layer made of Ru or Ru alloy is provided under a vertical magnetic layer in order to enhance vertical orientation of the vertical magnetic layer, there is a problem as follows. That is, if a substrate is heated immediately before the start of formation of the vertical magnetic layer and/or during the formation, crystal grains made of Ru or Ru alloy that forms the orientation control layer are coarsened. If the crystal grains made of Ru or Ru alloy are coarsened, an orientation control function as the orientation control layer is reduced, and thus, the grain diameter of magnetic grains of the vertical magnetic layer formed on the orientation control layer becomes large. As a result, even though the heating process of heating the substrate at a predetermined temperature is performed immediately before the start of formation of the vertical magnetic layer and/or during the formation, it is difficult to improve the vertical magnetic layer compared with the related art techniques.

In this manner, in a case where the heating process of heating the substrate at the predetermined temperature immediately before the start of formation of the vertical magnetic layer and/or during the formation, even though the orientation control layer made of Ru or Ru alloy is provided under the vertical magnetic layer, it is difficult to sufficiently achieve the effect due to provision of the orientation control layer.

Hence, the present inventors researched a technique of enhancing heat resistance of an orientation control layer made of Ru or Ru alloy so as to achieve an improvement effect of vertical orientation of a vertical magnetic layer due to the orientation control layer even if a substrate on which the orientation control layer is formed in advance is heated immediately before the start of formation of the vertical magnetic layer and/or during the formation.

As a result, the present inventors found that it was preferable that a diffusion prevention layer made of a material having a melting point of 1500° C. or higher and formed by a covalent bond or an ionic bond be provided on a surface of an Ru layer or an Ru alloy layer that formed the orientation control layer on the side of the vertical magnetic layer.

More specifically, by providing the diffusion prevention layer on the surface of the Ru layer or the Ru alloy layer that forms the orientation control layer on the side of the vertical magnetic layer, it is possible to prevent Ru atoms included in the orientation control layer from being diffused due to heating. As a result, it is possible to suppress coarsening of crystal grains made of Ru or Ru alloy due to heating, and to enhance heat resistance of the orientation control layer.

Accordingly, in a case where the diffusion prevention layer is provided on the surface of the Ru layer or the Ru alloy layer that forms the orientation control layer on the side of the vertical magnetic layer, even if the heating process of heating the substrate at the predetermined temperature is performed immediately before the start of formation of the vertical magnetic layer to be formed on the diffusion prevention layer and/or during the formation, it is possible to suppress the coarsening of the crystal grains made of Ru or Ru alloy due to heating. Thus, for example, in a case where the Ru layer or the Ru alloy layer that forms the orientation control layer has a columnar crystalline grain structure, the columnar crystalline grain structure is maintained even after the heating process.

That is, by the diffusion prevention layer provided on the surface of the Ru layer or the Ru alloy layer that forms the orientation control layer on the side of the vertical magnetic layer, it is possible to achieve the following effects. That is, by performing the heating process immediately before the start of formation of the vertical magnetic layer and/or during the formation in manufacturing a magnetic recording medium in which the vertical magnetic layer is formed on the diffusion prevention layer, it is possible to form a vertical magnetic layer having excellent crystallinity and vertical orientation caused by both effects of an improvement effect of the vertical magnetic layer due to the heating process and a control effect of vertical orientation of the vertical magnetic layer due to the orientation control layer. As a result, it is possible to realize a magnetic recording medium suitable for high-density recording of an HDD.

That is, the invention provides the following means.

(1) A magnetic recording medium in which, on a non-magnetic substrate, at least an orientation control layer that controls orientation of a layer immediately above and a vertical magnetic layer in which an easy axis of magnetization is mainly vertically oriented with respect to the non-magnetic substrate are laminated, in which the orientation control layer includes an Ru-containing layer containing Ru or Ru alloy, and a diffusion prevention layer that is provided on the Ru-containing layer on the side of the vertical magnetic layer, is made of a material having a melting point of 1500° C. or higher and 4215° C. or lower, and is formed by a covalent bond or an ionic bond and prevents thermal diffusion of Ru atoms in the Ru-containing layer, and the vertical magnetic layer has a crystalline structure of crystal grains that is continuously formed from the Ru-containing layer with the diffusion prevention layer interposed therebetween and includes a columnar crystal that is continuously formed in a thickness direction together with the crystal grains.

(2) The magnetic recording medium according to (1), in which the Ru-containing layer includes a first Ru-containing layer and a second Ru-containing layer disposed on the first Ru-containing layer on the side of the vertical magnetic layer, the first Ru-containing layer includes crystalline structure as a nucleus of columnar crystalline structure, and the second Ru-containing layer includes columnar crystalline structure continuously formed in the thickness direction to the crystal that is the nucleus and is formed with a dome-shaped convex part at the top thereof.

(3) The magnetic recording medium according to (1) or (2), in which a second diffusion prevention layer that is made of a material having a melting point of 1500° C. or higher and 4215° C. or lower and formed by a covalent bond or an ionic bond and prevents the thermal diffusion of the Ru atoms of the Ru-containing layer is provided on the Ru-containing layer on the side of the non-magnetic substrate.

(4) The magnetic recording medium according to (2), in which an intermediate diffusion prevention layer that is made of a material having a melting point of 1500° C. or higher and 4215° C. or lower and formed by a covalent bond or an ionic bond and prevents the thermal diffusion of the Ru atoms of the Ru-containing layer is provided between the first Ru-containing layer and the second Ru-containing layer.

(5) The magnetic recording medium according to (1) or (2), in which the diffusion prevention layer includes any one selected from a group including AlN, SiO₂, MgO, Ta₂O₅, Cr₂O₃ and ZrO₂.

(6) The magnetic recording medium according to any one of (1) to (5), in which a soft magnetic underlayer is provided on the orientation control layer on the side of the non-magnetic substrate.

(7) The magnetic recording medium according to any one of (1) to (6), in which the vertical magnetic layer includes an alloy having an L1₀ crystalline structure as a main component.

(8) A method for manufacturing a magnetic recording medium, including: an orientation control layer forming process of forming an orientation control layer that controls orientation of a layer immediately above on a non-magnetic substrate; and a vertical magnetic layer forming process of forming, on the non-magnetic substrate, a vertical magnetic layer in which an easy axis of magnetization is mainly vertically oriented with respect to the non-magnetic substrate, in which the orientation control layer forming process includes a process of forming an Ru-containing layer containing Ru or Ru alloy, and a process of forming, on the Ru-containing layer, a diffusion prevention layer that is made of a material having a melting point of 1500° C. or higher and 4215° C. or lower and formed by a covalent bond or an ionic bond and prevents thermal diffusion of Ru atoms of the Ru-containing layer, and the vertical magnetic layer forming process includes a heating process of heating the non-magnetic substrate at 300° C. to 700° C. immediately before the start of formation of the vertical magnetic layer and/or during the formation to form the vertical magnetic layer that has a crystalline structure of crystal grains that is continuously formed from the Ru-containing layer with the diffusion prevention layer interposed therebetween and includes a columnar crystal that is continuously formed in a thickness direction together with the crystal grains.

(9) The method for manufacturing a magnetic recording medium according to (8), in which in the process of forming the diffusion prevention layer, the diffusion prevention layer that includes any one selected from a group including AlN, SiO₂, MgO, Ta₂O₅, Cr₂O₃ and ZrO₂ is formed.

(10) The method for manufacturing a magnetic recording medium according to (8) or (9), in which a process of forming a soft magnetic underlayer on the non-magnetic substrate is performed before the orientation control layer forming process.

(11) A magnetic recording and reproducing device including: the magnetic recording medium according to any one of (1) to (7); a medium drive unit that drives the magnetic recording medium in a recording direction; a magnetic head that performs a recording operation and a reproducing operation with respect to the magnetic recording medium; a head drive unit that relatively moves the magnetic head with respect to the magnetic recording medium; and a recording and reproducing signal-processing system that performs input of a signal to the magnetic head and reproduction of an output signal from the magnetic head.

(12) The magnetic recording and reproducing device according to (11), in which the magnetic head includes a laser generating unit that heats the magnetic recording medium, a wave guide that guides laser light generated from the laser generating unit to a tip portion thereof, and a near-field generating element provided at the tip portion.

Since the magnetic recording medium according to the invention includes an orientation control layer that includes an Ru-containing layer containing Ru or Ru alloy, and a diffusion prevention layer that is provided on the Ru-containing layer on the side of a vertical magnetic layer, is made of a material having a melting point of 1500° C. or higher and 4215° C. or lower and formed by a covalent bond or an ionic bond and prevents thermal diffusion of Ru atoms of the Ru-containing layer, it is possible to achieve excellent heat resistance of the orientation control layer.

Accordingly, since the magnetic recording medium according to the invention is manufactured by a method including the heating process of heating a non-magnetic substrate at 300° C. to 700° C. immediately before the start of formation of the vertical magnetic layer and/or during the formation, it is possible to provide a magnetic recording medium that includes a vertical magnetic layer having excellent vertical orientation and high crystallinity of crystal grains.

Further, the method for manufacturing the magnetic recording medium according to the invention is a method in which the orientation control layer forming process includes the process of forming the diffusion prevention layer that is made of a material having a melting point of 1500° C. or higher and 4215° C. or lower and formed by a covalent bond or an ionic bond and prevents thermal diffusion of Ru atoms of the Ru-containing layer, and the vertical magnetic layer forming process includes the heating process of heating the non-magnetic substrate at 300° C. to 700° C. immediately before the start of formation of the vertical magnetic layer and/or during the formation. Accordingly, in the method for manufacturing the magnetic recording medium according to the invention, it is possible to improve the vertical magnetic layer while suppressing reduction of a control effect of vertical orientation of the vertical magnetic layer due to the orientation control layer, in the heating process. As a result, according to the method for manufacturing the magnetic recording medium according to the invention, it is possible to easily manufacture a magnetic recording medium suitable for high-density recording of an HDD provided with a vertical magnetic layer having excellent vertical orientation and crystallinity.

### BRIEF DESCRIPTION OF THE DRAWINGS

FIG. 1 is a cross-sectional view schematically illustrating an example of a magnetic recording medium according to an embodiment of the invention.

FIG. 2 is an enlarged view schematically illustrating a laminated structure of an orientation control layer and a vertical magnetic layer that form the magnetic recording medium shown in FIG. 1.

FIG. 3 is a perspective view illustrating an example of a magnetic recording and reproducing device according to an embodiment of the invention.

FIG. 4 is a diagram illustrating another example of the magnetic recording and reproducing device according to the embodiment of the invention, which is a cross-sectional view schematically illustrating a configuration of a magnetic head provided in the magnetic recording and reproducing device.

FIG. 5 is a picture obtained by observing a front surface (Ru thin film) of a laminated thin film substrate in Test 1 using an atomic force microscope (AFM).

FIG. 6 is a picture obtained by observing a front surface (Ru thin film) of a laminated thin film substrate in Test 2 using an atomic force microscope (AFM).

FIG. 7 is a picture obtained by observing a front surface (AlN thin film) of a laminated thin film substrate in Test 3 using an atomic force microscope (AFM).

FIG. 8 is a graph illustrating a relationship between an average crystal grain diameter of crystal grains of a front surface of a laminated structure in Test 4 to Test 7 and a heating temperature.

FIG. 9 is a graph illustrating a relationship between an average crystal grain diameter of crystal grains of a front surface of a laminated structure in Test 8 to Test 12 and a heating temperature.

### DETAILED DESCRIPTION OF THE INVENTION

Hereinafter, a magnetic recording medium, a method for manufacturing the magnetic recording medium, and a magnetic recording and reproducing device of the invention will be described in detail referring to the accompanying drawings. In the drawings used in the following description, characteristic parts may be enlarged and shown for convenience in order to easily describe characteristics of the invention, and a size ratio or the like of respective components may be different from an actual size ratio.

(Magnetic Recording Medium)

The magnetic recording medium according to an embodiment of the invention is obtained by laminating, on a non-magnetic substrate, at least an orientation control layer that controls orientation of a layer immediately above and a vertical magnetic layer in which an easy axis of magnetization is mainly vertically oriented with respect to the non-magnetic substrate.

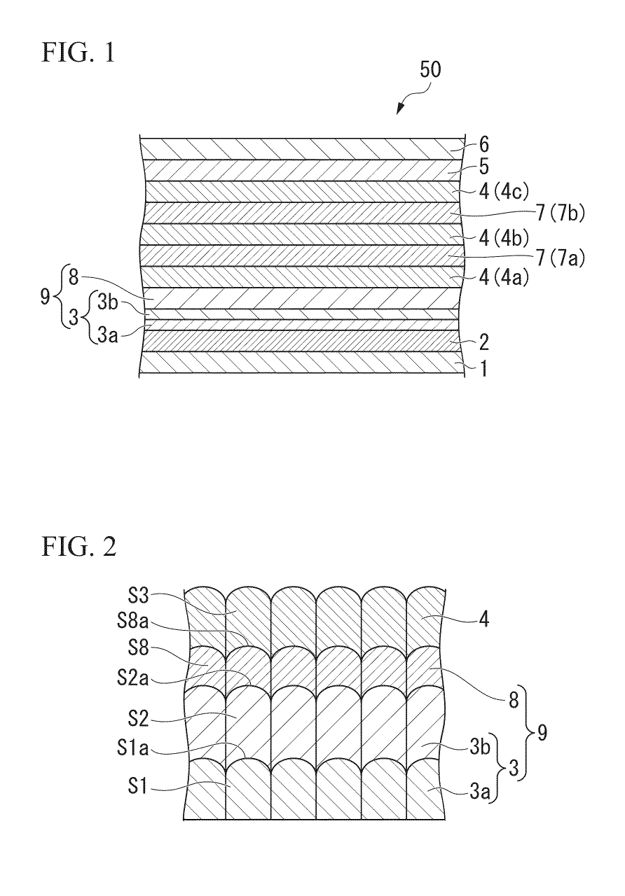

FIG. 1 is a cross-sectional view schematically illustrating an example of the magnetic recording medium according to the embodiment of the invention. A magnetic recording medium 50 shown in FIG. 1 is obtained by sequentially laminating a soft magnetic underlayer 2, an orientation control layer 9, a vertical magnetic layer 4, a protective layer 5 and a lubricant layer 6 on a non-magnetic substrate 1.

Further, the magnetic recording medium 50 shown in FIG. 1 is manufactured by a method including a heating process of heating the non-magnetic substrate 1 at 300° C. to 700° C. immediately before the start of formation of the vertical magnetic layer 4 and/or during the formation.

[Non-Magnetic Substrate]

As the non-magnetic substrate 1, a metal substrate formed of a metallic material such as aluminum or aluminum alloy may be used, or a non-metal substrate formed of a non-metallic material such as glass, ceramic, silicon, silicon carbide or carbon may be used. Further, as the non-magnetic substrate 1, a substrate obtained by forming an NiP layer or an NiP alloy layer on a front surface of the metal substrate or the non-metal substrate using plating, sputtering or the like, for example, may be used.

An amorphous glass, a crystallized glass or the like may be used as the glass substrate, for example. A general-purpose soda lime glass, an aluminosilicate glass or the like may be used as the amorphous glass, for example. Further, a lithium-based crystallized glass or the like may be used as the crystallized glass, for example. As the ceramic substrate, a sintered body that includes general-purpose aluminum oxide, aluminum nitride, silicon nitride or the like as a main component, a fiber reinforcer thereof, or the like may be used, for example.

Since the non-magnetic substrate 1 is in contact with the soft magnetic underlayer 2 in which Co or Fe is used as a main component, the non-magnetic substrate 1 may be corroded due to the influence of gas or moisture adsorbed on the front surface thereof, diffusion of the substrate components, or the like. Thus, it is preferable to provide an adhesion layer between the non-magnetic substrate 1 and the soft magnetic underlayer 2. By providing the adhesion layer, it is possible to suppress the corrosion.

Cr, Cr alloy, Ti, Ti alloy or the like may be appropriately selected as a material of the adhesion layer, for example. Further, it is preferable that the thickness of the adhesion layer be 2 nm (20 angstrom) or greater).

[Soft Magnetic Underlayer]

As shown in FIG. 1, the soft magnetic underlayer 2 is provided to be in contact with the orientation control layer 9 on the side of the non-magnetic substrate 1. The soft magnetic underlayer 2 increases a component, perpendicular to the surface of the substrate, of a magnetic flux that is generated from a magnetic head, and also firmly fixes the direction of magnetization of the vertical magnetic layer 4 on which information is to be recorded to a direction perpendicular to the non-magnetic substrate 1. An effect achieved by providing the soft magnetic underlayer 2 is particularly remarkable in a case where a single-pole head for vertical reading is used as a magnetic head for recording and reproducing.

A soft magnetic material that includes Fe, Ni, Co or the like may be used as the soft magnetic underlayer 2, for example. As the soft magnetic material, for example, a CoFe-based alloy (CoFeTaZr, CoFeZrNb or the like), an FeCo-based alloy (FeCo, FeCoV or the like), an FeNi-based alloy (FeNi, FeNiMo, FeNiCr, FeNiSi or the like), an FeAl-based alloy (FeAl, FeAlSi, FeAlSiCr, FeAlSiTiRu, FeAlO or the like), an FeCr-based alloy (FeCr, FeCrTi, FeCrCu or the like), an FeTa-based alloy (FeTa, FeTaC, FeTaN or the like), an FeMg-based alloy (FeMgO or the like), an FeZr-based alloy (FeZrN or the like), an FeC-based alloy, an FeN-based alloy, an FeSi-based alloy, an FeP-based alloy, an FeNb-based alloy, an FeHf-based alloy, an FeB-based alloy, or the like may be used.

It is preferable that the soft magnetic underlayer 2 be formed of two soft magnetic films, and it is preferable that an Ru film be provided between the two magnetic films. By adjusting the thickness of the Ru film in the range of 0.4 nm to 1.0 nm or 1.6 nm to 2.6 nm, it is possible to form two soft magnetic films in an AFC structure. In a case where the soft magnetic underlayer 2 employs such an AFC structure, it is possible to suppress a so-called spike noise.

In the magnetic recording medium according to the embodiment of the invention, it is preferable to arrange the soft magnetic underlayer 2 between the non-magnetic substrate 1 and the orientation control layer 9, but the soft magnetic underlayer 2 may not be provided.

[Orientation Control Layer]

The orientation control layer 9 is formed on the soft magnetic underlayer 2. The orientation control layer 9 controls orientation of the vertical magnetic layer 4 that is a layer immediately above, and reduces the size of crystal grains of the vertical magnetic layer 4, to thereby improve vertical orientation and to improve recording and reproducing characteristics. As the orientation control layer 9 is arranged, the vertical magnetic layer 4 has a same crystalline structure of crystal grains that form the orientation control layer 9 and a columnar crystal that is continuously grown in the thickness direction (perpendicular to the surface of the substrate) together with the crystal grains of the orientation control layer 9. Accordingly, if the crystal grains of the orientation control layer 9 have a fine columnar crystal, the crystal grains of the vertical magnetic layer 4 also have a fine columnar crystal, and thus, the vertical orientation is increased and the recording and reproducing characteristic is improved.

FIG. 2 is an enlarged view schematically illustrating a laminated structure of the orientation control layer 9 and the vertical magnetic layer 4 that form the magnetic recording medium 50 shown in FIG. 1. As shown in FIG. 2, in the magnetic recording medium 50 according to the present embodiment, the columnar crystals of the respective layers that form the orientation control layer 9 and the vertical magnetic layer 4 are continuously grown in the direction perpendicular to the surface of the substrate.

As shown in FIG. 1 and FIG. 2, in the magnetic recording medium 50 according to the present embodiment, the orientation control layer 9 includes an Ru-containing layer 3 that includes Ru or Ru alloy; and a diffusion prevention layer 8 that is provided on the Ru-containing layer 3 on the side of the vertical magnetic layer 4 and prevents thermal diffusion of Ru atoms of the Ru-containing layer 3.

As the Ru alloy used in the Ru-containing layer 3, it is preferable to use an alloy that includes any one element selected from Re, Cu, Fe, Mn, Ir and Ni with respect to Ru be used in order to prevent the diffusion of the Ru atoms on the orientation control layer 9 due to heating. The content of the element included in the Ru alloy is preferably in the range of 20 atomic % to 80 atomic %.

Further, in the embodiment shown in FIG. 1 and FIG. 2, the Ru-containing layer 3 includes a first Ru-containing layer 3a that is arranged on the side of the non-magnetic substrate 1, and a second Ru-containing layer 3b that is arranged on the first Ru-containing layer 3a on the side of the vertical magnetic layer 4. In the present embodiment, since the Ru-containing layer 3 includes the first Ru-containing layer 3a and the second Ru-containing layer 3b, it is possible to effectively control the orientation of the vertical magnetic layer 4, compared with a case where the Ru-containing layer 3 is formed of a single layer, for example.

The first Ru-containing layer 3a and the second Ru-containing layer 3b may be formed of the same material, or may be formed of different materials.

The first Ru-containing layer 3a is provided to increase the density of nucleation of the orientation control layer 9, and includes a crystal that is nucleus of the columnar crystal. In the first Ru-containing layer 3a, as shown in FIG. 2, a dome-shaped convex part S1a is formed at the top of a columnar crystal S1 obtained as the crystal that is the nucleus is grown.

It is preferable that the thickness of the first Ru-containing layer 3a be 5 nm or greater so that the dome-shaped convex part S1a is formed at the top of the columnar crystal S1 obtained as the crystal that is the nucleus is grown. With the thickness of 5 nm or greater, it is possible to easily form the dome-shaped convex part S1a at the top of the first Ru-containing layer.

In the embodiment shown in FIG. 2, the second Ru-containing layer 3b includes a columnar crystal S2 in which a dome-shaped convex part S2a is formed at the top thereof. The columnar crystal S2 of the second Ru-containing layer 3b is continuously formed to the crystal that is the nucleus of the columnar crystal S1 included in the first Ru-containing layer 3a in the thickness direction. In the present embodiment, the columnar crystal S2 of the second Ru-containing layer 3b is continuously grown in the thickness direction together with the columnar crystal S1 that forms the first Ru-containing layer 3a on the convex part S1a of the columnar crystal S1 included in the first Ru-containing layer 3a.

It is preferable that the thickness of the second Ru-containing layer 3b be 10 nm or greater so as to effectively control the orientation of the vertical magnetic layer 4. With the thickness of 10 nm or greater, the orientation of the vertical magnetic layer 4 is improved and the magnetic grains that form the vertical magnetic layer 4 are effectively made fine, and thus, an excellent S/N ratio is obtained.

Further, the diffusion prevention layer 8 is made of a material having a melting point of 1500° C. or higher and 4215° C. or lower and formed by a covalent bond or an ionic bond. Such a material is barely changed by heat and has excellent heat resistance. Accordingly, by arranging the diffusion prevention layer 8 on the Ru-containing layer 3 on the side of the vertical magnetic layer 4, it is possible to cause the diffusion prevention layer 8 to function as a barrier layer of the Ru-containing layer 3 against heat.

As shown in FIG. 1 and FIG. 2, the diffusion prevention layer 8 is arranged as the highest layer of the orientation control layer 9, and thus forms the front surface of the orientation control layer 9. Accordingly, the diffusion prevention layer 8 is arranged being in contact with the vertical magnetic layer 4 immediately under the vertical magnetic layer 4.

As shown in FIG. 2, as the diffusion prevention layer 8 is formed on the Ru-containing layer 3, the crystalline structure of the crystal grains of the Ru-containing layer 3 is continuously formed. Accordingly, the diffusion prevention layer 8 includes a fine columnar crystal S8 that is continuously formed in the thickness direction together with the crystal grains of the Ru-containing layer 3. A dome-shaped convex part S8a is formed at the top of the columnar crystal S8 of the diffusion prevention layer 8, and a dense magnetic grain of the vertical magnetic layer 4 is grown in the column shape on the dome-shaped convex part S8a.

As a material used in the diffusion prevention layer 8, a material having a melting point of 1500° C. or higher and 4215° C. or lower and formed by a covalent bond or an ionic bond may be used. Although there is no particular limitation, in order to effectively prevent coarsening of the crystal grains made of Ru or Ru alloy due to heating, it is preferable to use a layer that includes any one selected from a group including AlN (covalent bond: a melting point of 2200° C.), SiO₂ (covalent bond: a melting point of 1650° C.), MgO (ionic bond: a melting point of 2800° C.), Ta₂O₅ (ionic bond: a melting point of 1872° C.), Cr₂O₃ (ionic bond: a melting point of 1990° C.) and ZrO₂ (ionic bond: a melting point of 2729° C.). 4215° C. or lower is set considering that a melting point of Tantalum hafnium carbide, which is one of the ionic bond material whose melting point is the highest of all materials available in this invention, is 4215° C.

As the material used in the diffusion prevention layer 8, particularly, in order to more effectively prevent the thermal diffusion of the Ru atoms of the Ru-containing layer 3, AlN, SiO₂ or MgO is more preferably used, and AlN is most preferably used.

In a case where the vertical magnetic layer 4 is a vertical magnetic layer of a thermally-assisted medium, it is preferable that the diffusion prevention layer 8 be formed of MgO. A lattice constant of MgO approaches an axial length of an FePt alloy or a CoPt alloy that has an L1₀ crystalline structure that is suitably used for the vertical magnetic layer of the thermally-assisted medium. Thus, by forming the vertical magnetic layer 4 in which the FePt alloy or the CoPt alloy is used as a main component on the diffusion prevention layer 8 made of MgO, it is possible to achieve more excellent orientation of the vertical magnetic layer 4.

Further, in a case where the diffusion prevention layer 8 made of MgO is formed on the Ru-containing layer 3, in order to further increase the orientation of the diffusion prevention layer 8 made of MgO, it is preferable to provide, between the Ru-containing layer 3 and the diffusion prevention layer 8 made of MgO, a layer that adjusts the lattice constants of both the layers.

In the magnetic recording medium 50 according to the present embodiment, the orientation control layer 9 includes the diffusion prevention layer 8. Thus, even though the heating process of heating the non-magnetic substrate at 300° C. to 700° C. is performed immediately before the start of formation of the vertical magnetic layer 4 and/or during the formation, the Ru atoms included in the Ru-containing layer 3 of the orientation control layer 9 are prevented from being diffused by heating. Thus, coarsening of the crystal grains made of Ru or Ru alloy due to heating is suppressed. Accordingly, in the magnetic recording medium 50 according to the present embodiment, the fine dome-shaped convex part S8a formed of the diffusion prevention layer 8 is formed on the front surface of the orientation control layer 9, and magnetic grains of the vertical magnetic layer 4 having fineness and high crystallinity are grown in the column shape on the dome-shaped convex part S8a of the front surface of the orientation control layer 9.

In the magnetic recording medium 50 according to the present embodiment, a diffusion prevention layer (a second diffusion prevention layer) that is made of a material having a melting point of 1500° C. or higher and 4215° C. or lower, and formed by a covalent bond or an ionic bond, and prevents the thermal diffusion of the Ru atoms of the Ru-containing layer may also be provided on the orientation control layer 9 on the side of the non-magnetic substrate 1. By providing the second diffusion prevention layer on the orientation control layer 9 on the side of the non-magnetic substrate 1, coarsening of the crystal grains made of Ru or Ru alloy due to heating is effectively suppressed, and the structure of the crystal grains of the Ru-containing layer 3 is more preferably maintained.

Further, as shown in FIG. 1 and FIG. 2, in a case where the Ru-containing layer 3 includes the first Ru-containing layer 3a and the second Ru-containing layer 3b, it is preferable that a diffusion prevention layer (an intermediate diffusion prevention layer) that is made of a material having a melting point of 1500° C. or higher and 4215° C. or lower, and formed by a covalent bond or an ionic bond, and prevents the thermal diffusion of the Ru atoms of the Ru-containing layer be provided on the first Ru-containing layer 3a on the side of the vertical magnetic layer 4 (between the first Ru-containing layer 3a and the second Ru-containing layer 3b in the example shown in FIG. 1 and FIG. 2). By providing the intermediate diffusion prevention layer between the first Ru-containing layer 3a and the second Ru-containing layer 3b, coarsening of the crystal grains made of Ru or Ru alloy due to heating is more effectively suppressed, and the structure of the crystal grains of the Ru-containing layer 3 is more preferably maintained.

As the second diffusion prevention layer and the intermediate diffusion prevention layer, a layer made of the same material as that of the diffusion prevention layer 8 may be used, and it is preferable to use a layer that includes any one selected from a group including AlN, SiO₂, MgO, Ta₂O₅, Cr₂O₃ and ZrO₂. Particularly it is preferable to use a layer made of AlN.

Further, in the magnetic recording medium 50 according to the present embodiment, an example in which the Ru-containing layer 3 includes the first Ru-containing layer 3a and the second Ru-containing layer 3b is described. However, the Ru-containing layer may include a single layer, or may include three or more layers. In a case where the Ru-containing layer includes a plurality of Ru-containing layers, it is preferable to provide an intermediate diffusion prevention layer between the Ru-containing layers that face each other. In a case where the Ru-containing layer includes three or more Ru-containing layers, two or more spaces between the Ru-containing layers that face each other are formed. In a case where the Ru-containing layer includes three or more Ru-containing layers, the intermediate diffusion prevention layer may be provided in all the two or more spaces between Ru-containing layers, or may be provided in only a part of the spaces between the Ru-containing layers. The intermediate diffusion layer may not be provided.

[Vertical Magnetic Layer]

The vertical magnetic layer 4 in which the easy axis of magnetization is mainly vertically oriented with respect to the non-magnetic substrate 1 is formed on the orientation control layer 9. The magnetic recording medium 50 shown in FIG. 1 is manufactured by the method including the heating process of heating the non-magnetic substrate 1 at 300° C. to 700° C. immediately before the start of formation of the vertical magnetic layer 4 and/or during the formation. Accordingly, the vertical magnetic layer 4 has excellent vertical orientation and crystallinity. Specifically, as shown in FIG. 2, the vertical magnetic layer 4 has the crystalline structure of crystal grains that is continuously formed from the Ru-containing layer 3 with the diffusion prevention layer 8 interposed therebetween and includes a columnar crystal S3 that is continuously formed in the thickness direction together with the crystal grains.

Further, in the present embodiment, a magnetic layer made of a c-axially oriented multilayer film is used as the vertical magnetic layer 4. As shown in FIG. 1, the vertical magnetic layer 4 includes three layers of a lower magnetic layer 4a, an intermediate magnetic layer 4b, and an upper magnetic layer 4c, when seen from the side of the non-magnetic substrate 1.

Further, as shown in FIG. 1, in the magnetic recording medium 50 according to the present embodiment, a lower non-magnetic layer 7a is arranged between the magnetic layer 4a and the magnetic layer 4b, and an upper non-magnetic layer 7b is arranged between the magnetic layer 4b and the magnetic layer 4c. Accordingly, the magnetic recording medium 50 shown in FIG. 1 has a structure in which the magnetic layers 4a to 4C and the non-magnetic layers 7a and 7b are alternately laminated.

In the vertical magnetic layer 4 shown in FIG. 1, crystal grains that form the magnetic layers 4a to 4c and the non-magnetic layers 7a and 7b have columnar crystals that are continuously formed from the columnar crystals of the orientation control layer 9, and are epitaxially grown to be continuous from the columnar crystals of the orientation control layer 9.

As a material suitable for the magnetic layers 4a and 4b, for example, 90 (Co14Cr18Pt)-10 (SiO₂) {a molar concentration calculated by considering magnetic grains formed of Cr of 14 at %, Pt of 18 at % and residual Co as a single compound is 90 mol %, and an oxide composition formed of SiO₂ is 10 mol %}, 92(Co10Cr16Pt)-8(SiO₂), 94(Co8Cr14Pt4Nb)-6(Cr₂O₃), (CoCrPt)—(Ta₂O₅), (CoCrPt)—(Cr₂O₃)—(TiO₂), (CoCrPt)—(Cr₂O₃)—(SiO₂), (CoCrPt)—(Cr₂O₃)—(SiO₂)—(TiO₂), (CoCrPtMo)—(TiO), (CoCrPtW)—(TiO₂), (CoCrPtB)—(Al₂O₃), (CoCrPtTaNd)—(MgO), (CoCrPtBCu)—(Y₂O₃), (CoCrPtRu)—(SiO₂), or the like may be used.

As a material suitable for the magnetic layer 4c, for example, Co14 to 24Cr8 to 22Pt {Cr of 14 to 24 at %, Pt of 8 to 22 at %, and residual Co} that is a CoCrPt-based material is preferable, and Co10 to 24Cr8 to 22Pt0 to 16B {Cr of 10 to 24 at %, Pt of 8 to 22 at %, B of 0 to 16 at %, and residual Co} that is a CoCrPtB-based material is preferable. As another material used in the magnetic layer 4c, Co10 to 24Cr8 to 22Pt1 to 5Ta {Cr of 10 to 24 at %, Pt of 8 to 22 at %, Ta of 1 to 5 at %, and residual Co} that is a CoCrPtTa-based material is preferable, and Co10 to 24Cr8 to 22Pt1 to 5Ta1 to 10B {Cr of 10 to 24 at %, Pt of 8 to 22 at %, Ta of 1 to 5 at %, B of 1 to 10 at %, and residual Co} that is a CoCrPtTaB-based material is preferable, and a CoCrPtBNd-based material, a CoCrPtTaNd-based material, a CoCrPtNb-based material, a CoCrPtBW-based material, a CoCrPtMo-based material, a CoCrPtCuRu-based material, a CoCrPtRe-based material, or the like may be used.

As the non-magnetic layer 7 (7a and 7b), for example, a layer made of Ru or Ru alloy may be used.

Particularly, by setting the thicknesses of the non-magnetic layers 7a and 7b in the range of 0.6 nm or more and 1.2 nm or less, it is possible to form the magnetic layers 4a, 4b and 4c by AFC coupling (anti-ferromagnetism exchange coupling). Further, in the present embodiment, the respective magnetic layers 4a, 4b and 4c may be magneto-statically coupled by FC coupling (ferromagnetism exchange coupling).

Further, in a case where the vertical magnetic layer 4 in the present embodiment is the vertical magnetic layer of the thermally-assisted medium, it is preferable to use a layer that includes an alloy that has an L1₀ crystalline structure as a main component as the vertical magnetic layer. As the alloy that has the L1₀ crystalline structure, it is preferable to use an alloy that includes an FePt alloy that has the L1₀ crystalline structure as a main component, and has a granular structure that includes at least one oxide or two or more oxides selected from SiO₂, TiO₂, Ta₂O₅, ZrO₂, Al₂O₃, Cr₂O₃, and MgO. Further, the FePt alloy that has the L1₀ crystalline structure may include at least one element or two or more elements selected from Cu, Ag and Ni, in order to reduce an ordering temperature and/or a Curie temperature.

Further, the vertical magnetic layer of the thermally-assisted medium includes a CoPt alloy of an HCP structure as a main component, and may be formed of an alloy of a granular structure that includes at least one oxide or two or more oxides selected from SiO₂, TiO₂, Ta₂O₅, ZrO₂, Al₂O₃, Cr₂O₃, and MgO.

Further, as the vertical magnetic layer of the thermally-assisted medium, a layer that includes a CoPt alloy having the L1₀ crystalline structure with high magneto crystalline anisotropy, or a layer that includes an alloy having a rare earth metal as a main component, such as an SmCo alloy, an NdFeB alloy, a TbFeCo alloy or the like, may be used.

Further, as the vertical magnetic layer of the thermally-assisted medium, a multilayer film that includes a Co film and a Pd film or a multilayer film that includes a Co film and a Pt film may be used.

[Protective Layer]

As shown in FIG. 1, the protective layer 5 is formed on the vertical magnetic layer 4. The protective layer 5 is provided to prevent corrosion of the vertical magnetic layer 4 and to prevent damage of the surface of the medium when the magnetic head is in contact with the magnetic recording medium 50. As the protective layer 5, a known material in the related art may be used. For example, a material that includes C, SiO₂ and ZrO₂ may be used. The thickness of the protective layer 5 is preferably set to 1 nm to 10 nm, to thereby make it possible to reduce the distance between the magnetic head and the magnetic recording medium 50, which is also preferable in view of high-density recording.

[Lubricant Layer]

The lubricant layer 6 is formed on the protective layer 5. For example, a lubricant such as perfluoropolyether, fluorinated alcohol or fluorinated carboxylic acid may be preferably used as the lubricant layer 6.

(Method for Manufacturing Magnetic Recording Medium)

Next, with respect to a method for manufacturing the magnetic recording medium according to the invention, a method for manufacturing the magnetic recording medium 50 shown in FIG. 1 will be described as an example.

In manufacturing the magnetic recording medium 50 shown in FIG. 1, first, the adhesion layer is formed on the non-magnetic substrate 1 by sputtering or the like, and the soft magnetic underlayer 2 is formed on the adhesion layer by sputtering or the like.

Then, the orientation control layer 9 is formed on the soft magnetic underlayer 2 (orientation control layer forming process), the vertical magnetic layer 4 is formed on the orientation control layer 9 (vertical magnetic layer forming process), and the protective layer 5 and the lubricant layer 6 are sequentially formed on the vertical magnetic layer 4.

In the orientation control layer forming process of the present embodiment, a process of forming the Ru-containing layer 3 by sputtering or the like is performed. In the process of forming the Ru-containing layer 3, a first Ru-containing layer forming process of forming the first Ru-containing layer 3a is performed, and a second Ru-containing layer forming process of forming the second Ru-containing layer 3b is performed after the first Ru-containing layer forming process.

In the first Ru-containing layer forming process, it is preferable to form the first Ru-containing layer 3a by sputtering in the range of a sputtering gas pressure of 0.5 Pa to 5 Pa. By setting the sputtering gas pressure when the first Ru-containing layer 3a is formed in the above-mentioned range, the first Ru-containing layer 3a that includes a crystal that serves as a nucleus of a columnar crystal that forms the orientation control layer 9 is easily formed. If the sputtering gas pressure when the first Ru-containing layer 3a is formed is less than the above-mentioned range, the orientation of the formed first Ru-containing layer 3a is reduced and the effect of achieving fine magnetic grains that form the vertical magnetic layer 4 may be insufficient. Further, if the sputtering gas pressure when the first Ru-containing layer 3a exceeds the above-mentioned range, the crystallinity of the formed first Ru-containing layer 3a is reduced, the hardness of the first Ru-containing layer 3a is reduced, and the reliability of the magnetic recording medium 50 may be reduced.

In the second Ru-containing layer forming process, it is preferable to set the sputtering gas pressure to be a high pressure that is equal to or greater than the sputtering gas pressure when the first Ru-containing layer 3a is formed in the range of 5 Pa to 18 Pa, when the second Ru-containing layer 3b is formed by sputtering. By setting the sputtering gas pressure when the second Ru-containing layer 3b is formed in the above-mentioned range, the second Ru-containing layer 3b is easily obtained that includes the columnar crystal S2 that is continuously formed in the thickness direction to the crystal that serves as the nucleus of the columnar crystal S1 included in the first Ru-containing layer 3a and is formed with the dome-shaped convex part S2a at the top thereof.

If the sputtering gas pressure when the second Ru-containing layer 3b is formed is less than the above-mentioned range, the crystal grains of the vertical magnetic layer 4 grown on the orientation control layer 9 are separated, the effect of achieving fine magnetic grains of the vertical magnetic layer 4 may be insufficient, and excellent S/N ratio and thermal fluctuation characteristic are barely obtained. Further, if the sputtering gas pressure when the second Ru-containing layer 3b is formed exceeds the above-mentioned range, the hardness of the second Ru-containing layer 3b may be insufficient.

Then, a process of forming the diffusion prevention layer 8 made of a material having a melting point of 1500° C. or higher and 4215° C. or lower and formed by a covalent bond or an ionic bond on the Ru-containing layer 3 of the orientation control layer 9 by sputtering or the like, is performed. Through this process, the orientation control layer 9 shown in FIG. 1 is formed.

In a case where the Ru-containing layer 3 includes the first Ru-containing layer 3a and the second Ru-containing layer 3b and the intermediate diffusion prevention layer is provided between the first Ru-containing layer 3a and the second Ru-containing layer 3b, the intermediate diffusion prevention layer is formed on the first Ru-containing layer 3a in a similar way to the process of forming the diffusion prevention layer, between the process of forming the first Ru-containing layer 3a and the process of forming the second Ru-containing layer 3b.

Further, in a case where the second diffusion prevention layer is provided on the orientation control layer 9 on the side of the non-magnetic substrate 1, before performing the process of forming the Ru-containing layer 3, the second diffusion prevention layer is formed on the non-magnetic substrate 1 on which the soft magnetic underlayer 2 is formed in a similar way to the process of forming the diffusion prevention layer.

Next, the vertical magnetic layer 4 is formed on the orientation control layer 9 by sputtering or the like (the vertical magnetic layer forming process). In the vertical magnetic layer forming process of the present embodiment, the vertical magnetic layer 4 has the crystalline structure of the crystal grains that is continuously formed from the Ru-containing layer 3 with the diffusion prevention layer 8 interposed therebetween and includes the columnar crystal that is continuously formed in the thickness direction together with the crystal grains of the Ru-containing layer 3, is formed. Further, the vertical magnetic layer forming process of the present embodiment includes the heating process of heating the non-magnetic substrate 1 at 300° C. to 700° C. immediately before the start of formation of the vertical magnetic layer 4 and/or during the formation.

If the non-magnetic substrate 1 in the heating process is within the range of 300° C. to 700° C., an improvement effect of the vertical magnetic layer 4 due to the heating process is sufficiently achieved. If the temperature of the non-magnetic substrate 1 in the heating process is less than the above-mentioned range, the improvement effect of the vertical magnetic layer 4 is not sufficiently achieved. Further, if the temperature of the non-magnetic substrate 1 in the heating process exceeds the above-mentioned range, the effect of maintaining the crystalline grain structure of the Ru-containing layer 3 by the diffusion prevention layer 8 is insufficient, and thus, it is difficult to secure the vertical orientation of the vertical magnetic layer 4.

The heating process may be performed only immediately before the formation of the vertical magnetic layer 4, may be continuously performed from immediately before the formation of the vertical magnetic layer 4 to completion of the formation, or may be performed only during the formation of the vertical magnetic layer 4, for example. Further, the temperature of the non-magnetic substrate 1 in the heating process may be constant, or may be changed, which may be appropriately determined according to the purpose of the heating process.

In the present embodiment, even in a case where the heating process is performed after the formation of the vertical magnetic layer 4, the effect of maintaining the crystalline grain structure of the Ru-containing layer 3 due to the diffusion prevention layer 8 is achieved. However, if the heating process in the above-mentioned temperature range is performed after the formation of the vertical magnetic layer 4, the crystalline grains of the vertical magnetic layer 4 may be coarsened. Thus, in order to obtain the fine vertical magnetic layer 4, it is preferable that the heating process be not performed after the formation of the vertical magnetic layer 4.

In the present embodiment, the orientation control layer 9 includes the diffusion prevention layer 8 made of a material having a melting point of 1500° C. or higher and 4215° C. or lower and formed by a covalent bond or an ionic bond, on the Ru-containing layer 3 on the side of the vertical magnetic layer 4. Thus, even though the heating process in the above-mentioned temperature range is performed, the crystalline grain structure of the Ru-containing layer 3 is preferably maintained, and thus, the improvement effect of the vertical orientation of the vertical magnetic layer 4 due to the orientation control layer 9 is achieved. Consequently, as shown in FIG. 2, it is possible to preferably maintain the dome shape of the diffusion prevention layer 8 that forms the front surface of the orientation control layer 9, and thus, it is possible to form the vertical magnetic layer 4 that has fine columnar crystals and fine vertical orientation on the dome-shaped convex part S8a of the diffusion prevention layer 8.

As described above, in the present embodiment, it is possible to secure the vertical orientation of the vertical magnetic layer 4 by the effect of maintaining the crystalline grain structure of the Ru-containing layer 3 due to the diffusion prevention layer 8, and to improve the vertical magnetic layer 4.

Accordingly, in the present embodiment, even in the case of a material that cannot be used in the related art as a material of the vertical magnetic layer, if the material is capable of securing excellent quality as the vertical magnetic layer 4 by providing the diffusion prevention layer 8 on the Ru-containing layer 3 on the side of the vertical magnetic layer 4 and by performing the heating process, it is possible to use the material. Accordingly, in the magnetic recording medium 50 of the present embodiment, compared with the magnetic recording medium 50 in the related art, it is possible to widen the choice of materials capable of being used as the vertical magnetic layer 4.

The vertical magnetic layer 4 formed in the present embodiment may be a magnetic layer made of a c-axially oriented multilayer film, as shown in FIG. 1, for example, or may be a magnetic layer that includes an alloy that has an L1₀ crystalline structure as a main component, formed as a vertical magnetic layer of a thermally-assisted medium.

In a case where the vertical magnetic layer 4 formed in the vertical magnetic layer forming process of the present embodiment is made of the c-axially oriented multilayer film, the vertical magnetic layer 4 having high crystallinity of the crystal grains is obtained as the heating process is performed.

Particularly, in the heating process, in a case where the non-magnetic substrate 1 is heated immediately before the formation of the vertical magnetic layer 4, the formation is started in a state where the non-magnetic substrate 1 is heated at a predetermined temperature. Thus, disturbance of crystals of the vertical magnetic layer 4 formed immediately after the start of the formation is suppressed, and thus, the vertical magnetic layer 4 having higher crystallinity of the crystal grains is obtained, which is preferable.

In a case where the vertical magnetic layer 4 is made of the c-axially oriented multilayer film, the temperature of the non-magnetic substrate 1 in the heating process depends on the composition of an alloy, but is preferably 300° C. to 400° C.

In a case where the temperature of the non-magnetic substrate 1 in the heating process is in the range of 300° C. to 400° C., it is possible to further improve the crystallinity of the crystal grains of the vertical magnetic layer 4 while securing the vertical orientation of the vertical magnetic layer 4.

Further, in a case where the vertical magnetic layer 4 is made of the c-axially oriented multilayer film, the heating time in the heating process may be appropriately determined according to the thickness of the vertical magnetic layer 4 or the like. The heating time is not particularly limited, but is preferably set in the range of 1 second to 60 seconds. In this case, it is possible to more effectively achieve the improvement effect of the vertical magnetic layer 4 while securing the vertical orientation of the vertical magnetic layer 4.

Further, in a case where the vertical magnetic layer 4 is the magnetic layer that includes the alloy that has the L1₀ crystalline structure as the main component, formed as the vertical magnetic layer of the thermally-assisted medium, it is preferable to order the alloy that forms the vertical magnetic layer 4 by performing a heating process to form the L1₀ crystalline structure. In this case, the temperature of the non-magnetic substrate 1 in the heating process is set to be equal to or higher than the ordering temperature (phase transformation temperature from a disordered phase (fcc) to an ordered phase (fct)) of the alloy that forms the vertical magnetic layer 4.

In a case where the alloy that forms the vertical magnetic layer 4 is ordered in the heating process, it is sufficient if the heating process may order the alloy that forms the vertical magnetic layer 4. Accordingly, for example, the heating process may be continuously performed from immediately before the start of the formation of the vertical magnetic layer 4 to completion of the formation, may be performed from immediately before the start of the formation of the vertical magnetic layer 4 and be completed immediately after the start of the formation, may be performed only immediately before the start of the formation of the vertical magnetic layer 4, or may be performed only during the formation of the vertical magnetic layer 4. In a case where the heating process of ordering the alloy that forms the vertical magnetic layer 4 during the formation of the vertical magnetic layer 4 is performed, the heating process may be continuously performed from the start of the formation to completion of the formation, or may be performed only for a certain period during the formation.

Even though the alloy that forms the vertical magnetic layer 4 is ordered in the heating process, in a case where the non-magnetic substrate 1 is heated immediately before the start of the formation of the vertical magnetic layer 4, the formation is started in a state where the non-magnetic substrate 1 is heated at a predetermined temperature. Thus, disturbance of crystals of the vertical magnetic layer 4 formed immediately after the start of the formation is suppressed, and the vertical magnetic layer 4 having higher crystallinity of the crystal grains is obtained, which is preferable.

In a case where the alloy that forms the vertical magnetic layer 4 is ordered as the heating process is performed, the temperature of the non-magnetic substrate 1 in the heating process is appropriately determined according to the type of the alloy. For example, in a case where the alloy that forms the vertical magnetic layer 4 is FePt, by setting the temperature of the non-magnetic substrate 1 in the heating process in the range of 300° C. to 700° C., it is possible to reliably order the alloy that forms the vertical magnetic layer 4 while preferably securing the vertical orientation of the vertical magnetic layer 4. Thus, it is possible to further improve the crystallinity of the crystal grains of the vertical magnetic layer 4.

Subsequently, the protective layer 5 is formed on the vertical magnetic layer 4 using a chemical vapor deposition (CVD) method.

Then, by coating a lubricant on the protective layer 5 using a dipping method or the like, the lubricant layer 6 is formed.

According to the above-mentioned processes, the magnetic recording medium 50 shown in FIG. 1 is obtained.

(Magnetic Recording and Reproducing Device)

Next, a magnetic recording and reproducing device according to an embodiment of the invention will be described.

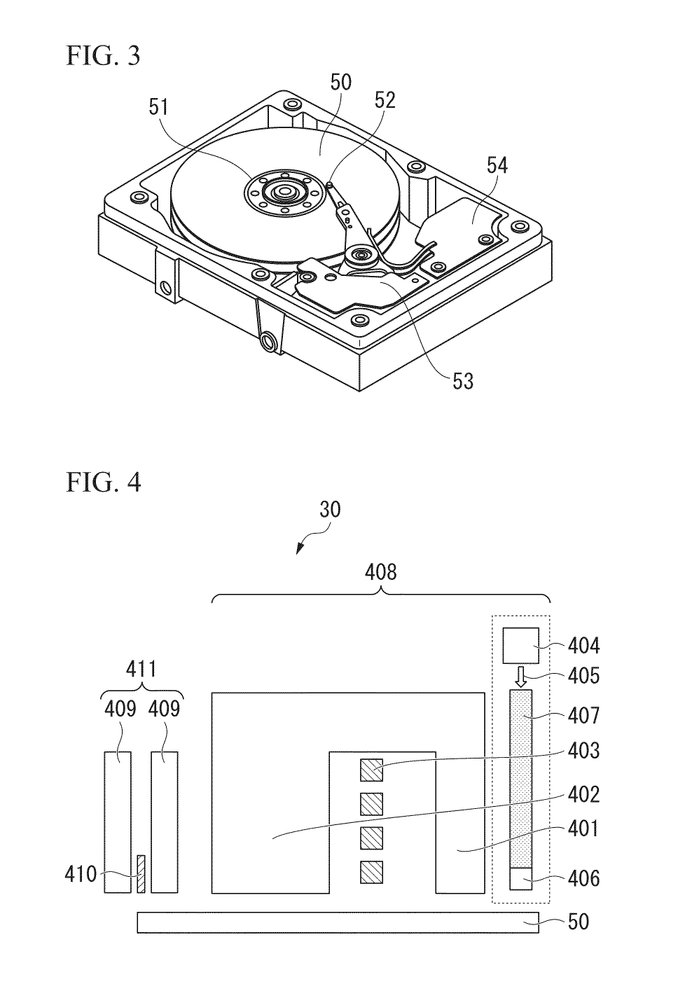

FIG. 3 is a perspective view illustrating an example of a magnetic recording and reproducing device according to an embodiment of the invention. The magnetic recording and reproducing device shown in FIG. 3 includes the magnetic recording medium 50 shown in FIG. 1, a medium drive unit 51 that drives the magnetic recording medium 50 to rotate, a magnetic head 52 that performs a recording operation and a reproducing operation with respect to the magnetic recording medium 50, a head drive unit 53 that relatively moves the magnetic head 52 with respect to the magnetic recording medium 50, and a recording and reproducing signal-processing system 54.

The recording and reproducing signal-processing system 54 is capable of processing data input from the outside to transmit a recording signal to the magnetic head 52, and of processing a reproducing signal from the magnetic head 52 to transmit data to the outside.

As the magnetic head 52, in a case where the magnetic recording medium 50 shown in FIG. 1 is configured so that the magnetic layer made of the c-axially oriented multilayer film is provided as the vertical magnetic layer 4, for example, it is preferable to use a magnetic head suitable for high-density recording, including a GMR element that uses a giant magnetoresistance effect (GMR), or the like as a reproducing element. Further, a single-pole head for vertical recording may be used as the magnetic head 52.

Since the magnetic recording and reproducing device shown in FIG. 3 includes the magnetic recording medium 50 shown in FIG. 1 and the magnetic head 52 that performs the recording operation and the reproducing operation with respect to the magnetic recording medium 50, the magnetic recording and reproducing device includes the magnetic recording medium 50 suitable for high-density recording.

Next, another example of a magnetic recording and reproducing device according to an embodiment of the invention will be described.

The magnetic recording and reproducing device according to the embodiment of the invention may include a thermally-assisted medium as a magnetic recording medium. In a case where the magnetic recording medium 50 is a thermally-assisted medium that includes the vertical magnetic layer 4 of the thermally-assisted medium, it is possible to use a magnetic head 30 shown in FIG. 4, for example, as a magnetic head in the magnetic recording and reproducing device shown in FIG. 3. FIG. 4 is a diagram illustrating another example of the magnetic recording and reproducing device according to the embodiment of the invention, which is a cross-sectional view schematically illustrating a configuration of a magnetic head provided in the magnetic recording and reproducing device.

The magnetic head 30 shown in FIG. 4 includes a recording head 408 and a reproducing head 411 as a schematic configuration. The recording head 408 includes a main pole 401, an auxiliary pole 402, a coil 403 configured to produce a magnetic field, a laser diode (LD) 404, a wave guide 407 that guides a laser light 405 generated from the LD 404 to a near-field generating element 406 provided at the tip thereof. The reproducing head 411 includes a reproducing element 410 such as a TMR element disposed between a pair of shields 409.

Further, in the magnetic recording and reproducing device that includes the magnetic head 30 shown in FIG. 4, a near-field light generated from the near-field generating element 406 of the magnetic head 30 shown in FIG. 4 irradiates the magnetic recording medium 50 to locally heat the front surface thereof, so that a coercive force of the vertical magnetic layer 4 of the magnetic recording medium 50 is temporarily reduced to a head magnetic field or lower to perform writing.

Since such a magnetic recording and reproducing device includes the magnetic head 30 shown in FIG. 4 as the magnetic head, and includes the magnetic recording medium 50 shown in FIG. 1 that is the thermally-assisted medium as the magnetic recording medium, the magnetic recording and reproducing device is suitable for high density recording.

### EXAMPLES

### Test 1 to Test 3

A Ta thin film of 5 nm (a sputtering gas pressure of 0.6 Pa), a Pt thin film of 6 nm (a sputtering gas pressure of 0.6 Pa), a Ru thin film of 10 nm (columnar crystal) (a sputtering gas pressure of 0.6 Pa), and a Ru thin film of 10 nm (columnar crystal) (a sputtering gas pressure of 8 Pa) were sequentially formed on a non-magnetic glass substrate by a sputtering method that uses Ar gas, to thereby obtain a laminated thin film substrate in Test 1.

Then, the laminated thin film substrate in Test 1 was heated for 10 seconds at 660° C., to thereby obtain a laminated thin film substrate in Test 2.

The surfaces (Ru thin films) of the laminated thin film substrates in Test 1 and Test 2 obtained as described above were observed using an atomic force microscope (AFM). The result is shown in FIG. 6.

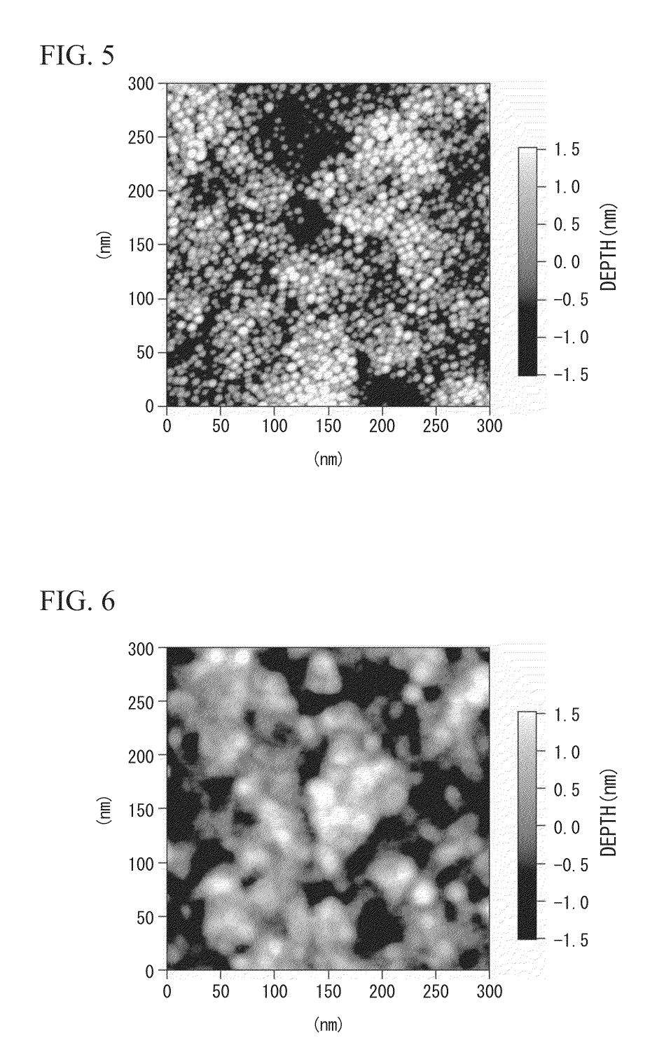

FIG. 5 is a picture obtained by observing the surface (Ru thin film) of the laminated thin film substrate in Test 1 using the atomic force microscope (AFM), and FIG. 6 is a picture obtained by observing the surface (Ru thin film) of the laminated thin film substrate in Test 2 using the atomic force microscope (AFM).

As shown in FIG. 5 and FIG. 6, the Ru thin films of the laminated thin film substrates in Test 1 and Test 2 included columnar crystals in which a dome-shaped convex part was formed at the top.

Further, compared with the laminated thin film substrate in Test 1 before heating shown in FIG. 5, it can be understood that crystal grains made of Ru are coarsened in the laminated thin film substrate in Test 2 after heating shown in FIG. 6.

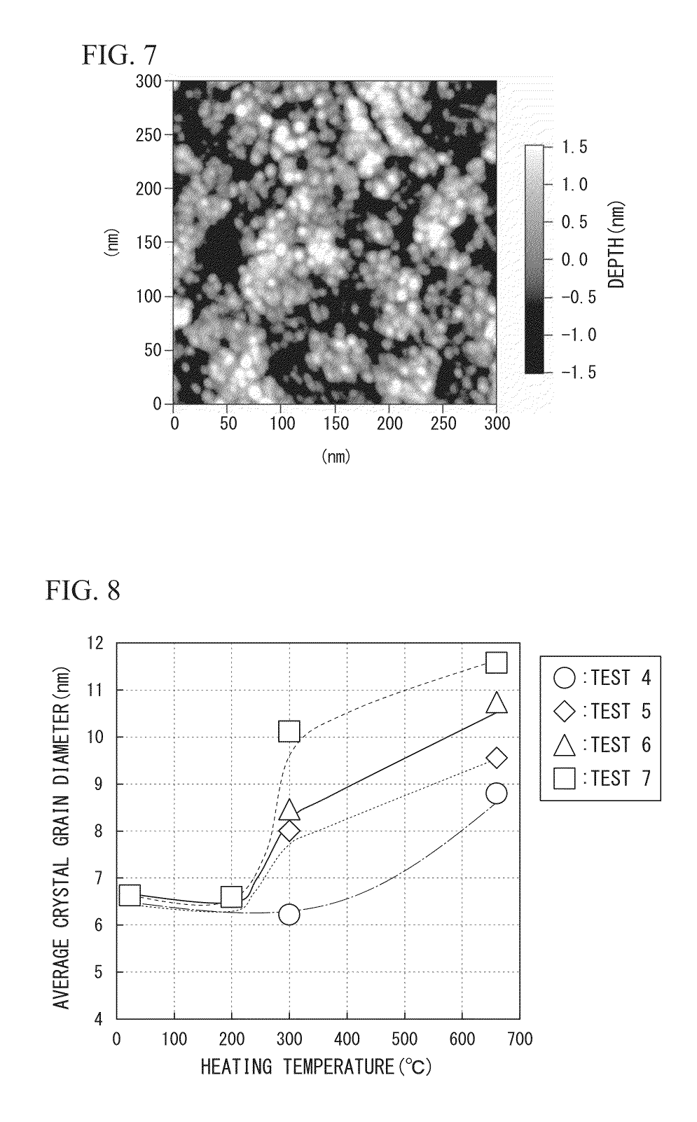

Further, an AlN thin film of 0.5 nm that was a diffusion prevention layer was formed on the surface of the laminated thin film substrate in Test 1 by sputtering, and the result was heated for 10 seconds at 660° C., to thereby obtain a laminated thin film substrate in Test 3. The surface (AlN thin film) of the obtained laminated thin film substrate in Test 3 was observed using the atomic force microscope (AFM). The result is shown in FIG. 7.

FIG. 7 is a picture obtained by observing the surface (AlN thin film) of the laminated thin film substrate in Test 3 using the atomic force microscope (AFM).

As shown in FIG. 7, the Ru thin film of the laminated thin film substrate in Test 3 included columnar crystals in which a dome-shaped convex part was formed at the top.

Further, in the laminated thin film substrate in Test 3 that was heated after the AlN thin film was formed on the Ru thin film shown in FIG. 7, it can be understood that the crystal grains of the surface were coarsened compared with the laminated thin film substrate in Test 1 shown in FIG. 5, but the coarsening was slight compared with the laminated thin film substrate in Test 2 shown in FIG. 6.

It can be understood that the coarsening of the crystal grains of the surface is suppressed by forming the AlN thin film on the Ru thin film, from FIGS. 5, 6 and 7. It is estimated that the AlN thin film acts as a barrier layer of the Ru thin film against heat to prevent thermal diffusion of Ru atoms, and thus, the coarsening of the crystal grains made of Ru is prevented, so that the shape of the columnar crystal in which the dome-shaped convex part is formed at the top of the Ru thin film is maintained.

### Test 4 to Test 7

A Ta thin film of 5 nm (a sputtering gas pressure of 0.6 Pa), a Pt thin film of 6 nm (a sputtering gas pressure of 0.6 Pa), an AlN thin film (1) of 0.5 nm, a Ru thin film of 10 nm (columnar crystal) (a sputtering gas pressure of 0.6 Pa), an AlN thin film (2) of 0.5 nm, a Ru thin film of 10 nm (columnar crystal) (a sputtering gas pressure of 8 Pa), and an AlN thin film (3) of 0.5 nm were sequentially formed on a non-magnetic glass substrate by a sputtering method that uses Ar gas, to thereby obtain a laminated thin film substrate in Test 4.

Then, an average crystal grain diameter of crystal grains of the surface (AlN thin film) of the laminated thin film substrate in Test 4 was measured. Further, the average crystal grain diameter of the crystal grains of the surface after the laminated structure in Test 4 was heated for 10 seconds at temperatures of 200° C., 300° C. and 660° C. was measured. Here, the average crystal grain diameter of the crystal grains was measured using the AFM. The result is shown in FIG. 8.

Further, in a similar way to Test 4, except that only the AlN thin films (1) and (3) among the AlN thin films (1), (2) and (3) in Test 4 were provided, each thin film was formed on a non-magnetic glass substrate, to thereby obtain a laminated thin film substrate in Test 5.

Further, in a similar way to Test 4, except that only the AlN thin film (3) among the AlN thin films (1), (2) and (3) in Test 4 was provided, each thin film was formed on a non-magnetic glass substrate, to thereby obtain a laminated thin film substrate in Test 6.

Further, in a similar way to Test 4, except that the AlN thin films (1), (2) and (3) in Test 4 were not provided, each thin film was formed on a non-magnetic glass substrate, to thereby obtain a laminated thin film substrate in Test 7.

With respect to the laminated thin film substrates in Test 5 to Test 7, an average crystal grain diameter of crystal grains of the surface (of the AlN thin film in Test 5 and Test 6, and of the Ru thin film in Test 7) was measured in a similar way to the laminated structure in Test 4. Further, the average crystal grain diameter of the crystal grains of the surface after each laminated structure in Test 5 to Test 7 was heated for 10 seconds at temperatures of 200° C., 300° C. and 660° C. was measured in a similar way to the laminated structure in Test 4. The result is shown in FIG. 8.

FIG. 8 is a graph illustrating the relationship between the average crystal grain diameter of the crystal grains of the surface of the laminated structure in Test 4 to Test 7 and the heating temperature.

As shown in FIG. 8, the laminated structure in Test 7 in which the AlN thin film is not provided is heated at a temperature of 300° C. or higher, and thus, the crystal grains of the surface of the laminated structure are considerably coarsened.

On the other hand, as shown in FIG. 8, in Test 6 in which the AlN thin film is provided only on the upper Ru thin film, the coarsening of the crystal grains of the surface of the laminated structure due to heating is suppressed, compared with Test 7.

In Test 5 in which the AlN thin film is provided on the upper Ru thin film and on the lower Ru thin film on the side of the non-magnetic substrate, the coarsening of the crystal grains of the surface of the laminated structure due to heating is further suppressed.

Further, in Test 4 in which the AlN thin film is respectively provided on the upper Ru thin film, between the upper Ru thin film and the lower Ru thin film, and on the lower Ru thin film, on the side of the non-magnetic substrate 1, the coarsening of the crystal grains of the surface of the laminated structure due to heating is further suppressed, compared with Test 5.

As described above, it can be understood that the suppression effect of the coarsening of the crystal grains of the surface of the laminated structure due to heating increases in the order of Test 4, Test 5 and Test 6 and the suppression effect gets larger as the number of AlN thin films gets large.

### Test 8 to Test 12

In a similar way to Test 5, except that the AlN thin films (1) and (3) in Test 5 were replaced with MgO thin films (1) and (3), each thin film was formed on a non-magnetic glass substrate, to thereby obtain a laminated thin film substrate in Test 8.

In a similar way to Test 5, except that the AlN thin films (1) and (3) in Test 5 were replaced with SiO₂ thin films (1) and (3), each thin film was formed on a non-magnetic glass substrate, to thereby obtain a laminated thin film substrate in Test 9.

In a similar way to Test 5, except that the AlN thin films (1) and (3) in Test 5 were replaced with Ta₂O₅ thin films (1) and (3), each thin film was formed on a non-magnetic glass substrate, to thereby obtain a laminated thin film substrate in Test 10.

In a similar way to Test 5, except that the AlN thin films (1) and (3) in Test 5 were replaced with Cr₂O₃ thin films (1) and (3), each thin film was formed on a non-magnetic glass substrate, to thereby obtain a laminated thin film substrate in Test 11.

In a similar way to Test 5, except that the AlN thin films (1) and (3) in Test 5 were replaced with Zr₂O₃ thin films (1) and (3), each thin film was formed on a non-magnetic glass substrate, to thereby obtain a laminated thin film substrate in Test 12.

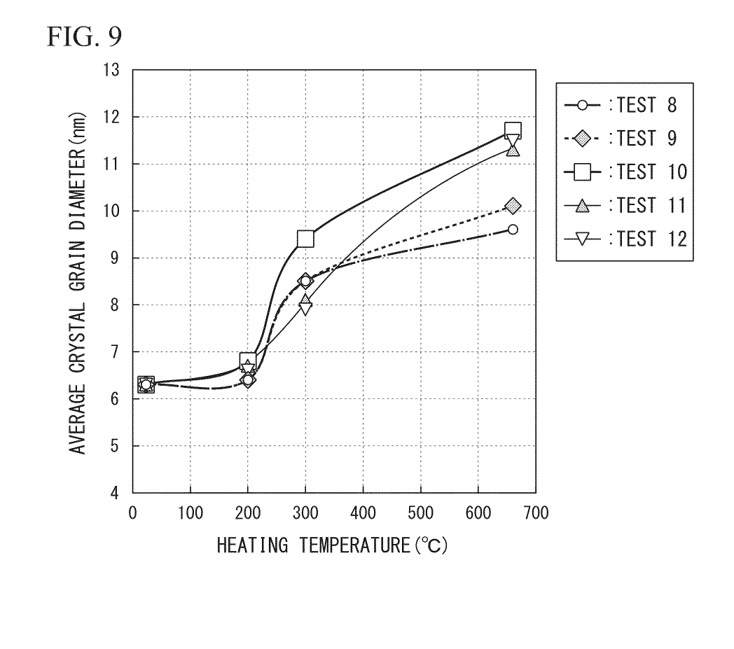

With respect to the laminated thin film substrates in Test 8 to Test 12, an average crystal grain diameter of crystal grains of the surface (of the MgO thin film in Test 8, of the SiO₂ thin film in Test 9, of the Ta₂O₅ thin film in Test 10, of the Cr₂O₃ thin film in Test 11, and of the Zr₂O₃ thin film in Test 12) was measured in a similar way to the laminated structure in Test 4. Further, the average crystal grain diameter of the crystal grains of the surface after each laminated structure in Test 8 to Test 12 was heated for 10 seconds at temperatures of 200° C., 300° C. and 660° C. was measured in a similar way to the laminated structure in Test 4. The result is shown in FIG. 9.

FIG. 9 is a graph illustrating the relationship between the average crystal grain diameter of the crystal grains of the surface of the laminated structure in Test 8 to Test 12 and the heating temperature.

As shown in FIG. 9, in Test 8 in which the MgO thin film is provided, in Test 9 in which the SiO₂ thin film is provided, in Test 10 in which the Ta₂O₅ thin film is provided, in Test 11 in which the Cr₂O₃ thin film is provided, and in Test 12 in which the Zr₂O₃ thin film is provided, compared with Test 7 shown in FIG. 8 in which the AlN thin film is not provided, the coarsening of the crystal grains of the surface of the laminated structure due to heating is suppressed.

Further, in Test 8 in which the MgO thin film is provided and in Test 9 in which SiO₂ thin film is provided, compared with Test 10 to Test 12, the coarsening of the crystal grains of the surface of the laminated structure due to heating is further suppressed.

As shown in FIG. 8 and FIG. 9, it can be understood that the suppression effect of the coarsening of the crystal grains of the surface of the laminated structure due to heating increases in the order of Test 5, Test 8 and Test 9, and that AlN, MgO or SiO₂ is preferably used as the material of the diffusion prevention layer and AlN is most preferably used. Further, with respect to Ta₂O₅, Cr₂O₃ or Zr₂O₃, the effect is shown from FIG. 9 in heating at a temperature of 600° C. or lower.

### EXAMPLES

Hereinafter, the effects of the invention will be described referring to examples. The invention is not limited to the following examples, and may be modified in a range without departing from the spirit thereof.

A magnetic recording medium was manufactured by the following method.

First, a glass substrate (manufactured by KONICA MINOLTA, Inc., an external size of 2.5 inches) after being washed was accommodated in a film formation chamber of a DC magnetron sputter device (trade name C-3040 manufactured by ANELVA CORPORATION), and then, the inside of the film formation chamber was exhausted until the degree of vacuum reached 1×10⁻⁵ Pa.

Then, an adhesion layer of a thickness of 10 nm was formed on the glass substrate using a Cr target.

Then, a soft magnetic layer of a thickness of 25 nm was formed at a substrate temperature of 100° C. or lower using a target made of Co-20Fe-5Zr-5Ta {Fe of 20 at %, Zr of 5 at %, Ta of 5 at %, and residual Co} on the adhesion layer, an Ru film of a thickness of 0.7 nm was formed thereon, and a soft magnetic layer of a thickness of 25 nm made of Co-20Fe-5Zr-5Ta was formed on the Ru film in a similar way to the soft magnetic layer, and to thereby form a soft magnetic underlayer in which the Ru film is provided between two soft magnetic layers.

Then, an orientation control layer was formed on the soft magnetic underlayer (orientation control layer forming process). That is, an AlN thin film of 0.5 nm (second diffusion prevention layer) (gas pressure of 0.6 Pa) was formed, a Ru thin film of 10 nm (first Ru-containing layer) was formed thereon at 0.6 Pa, an AlN thin film of 0.5 nm (intermediate diffusion prevention layer) was formed thereon, an Ru thin film of 10 nm (second Ru-containing layer) was formed thereon at 8 Pa, and a MgO layer of 10 nm (diffusion prevention layer) was formed thereon at 0.6 Pa.

Thereafter, a vertical magnetic layer of a thermally-assisted medium of a thickness of 8 nm that includes an alloy made of 90 mol % (Fe of 40 at % and Pt of 8 at % Ni) and 10 mol % (TiO₂) and having an L1₀ crystalline structure as a main component and has a granular structure including oxide was formed by sputtering (vertical magnetic layer forming process). When the vertical magnetic layer is formed, the non-magnetic substrate before the start of formation of the vertical magnetic layer was heated at 380° C. that was a temperature equal to or higher than an ordering temperature of the alloy that forms the vertical magnetic layer 4, and was maintained at 380° C. for 10 seconds after reaching 380° C. (heating process), and the formation of the vertical magnetic layer 4 was started while the temperature of the non-magnetic substrate was being maintained at 380° C.

Then, a protective layer of a thickness of 3.0 nm made of C was formed by a CVD method, and a lubricant made of perfluoropolyether was coated by a dipping method to form a lubricant layer. The magnetic recording medium was made through the above-described processes.

Thereafter, the magnetic recording medium that is the thermally-assisted medium obtained as described above was used as the magnetic recording medium of the magnetic recording and reproducing device shown in FIG. 3 that includes the magnetic head shown in FIG. 4, a recording pattern of a linear recording density of 1200 kFCI were written using the magnetic head.

Then, when the recording pattern of the magnetic recording medium was observed, a clear recording pattern was observed.

While preferred embodiments of the invention have been described and illustrated above, it should be understood that these are exemplary embodiments of the invention and are not to be considered as limiting. Additions, omissions, substitutions, and other modifications can be made without departing from the spirit or scope of the invention. Accordingly, the invention is not to be considered as being limited by the foregoing description, and is only limited by the scope of the appended claims.

What is claimed is:

1. A magnetic recording medium in which, on a non-magnetic substrate, at least an orientation control layer that controls orientation of a layer immediately above and a vertical magnetic layer in which an easy axis of magnetization is mainly vertically oriented with respect to the non-magnetic substrate are laminated,
wherein the orientation control layer includes an Ru-containing layer containing Ru or Ru alloy, and a diffusion prevention layer that is provided on the Ru-containing layer on the side of the vertical magnetic layer, is made of a material having a melting point of 1500° C. or higher and 4215° C. or lower, and is formed by a covalent bond or an ionic bond and prevents thermal diffusion of Ru atoms in the Ru-containing layer, and
the vertical magnetic layer has a crystalline structure of crystal grains that is continuously formed from the Ru-containing layer with the diffusion prevention layer interposed therebetween and includes a columnar crystal that is continuously formed in a thickness direction together with the crystal grains.

2. The magnetic recording medium according to claim 1,
wherein the Ru-containing layer includes a first Ru-containing layer and a second Ru-containing layer disposed on the first Ru-containing layer on the side of the vertical magnetic layer,
the first Ru-containing layer includes crystalline structure as a nucleus of columnar crystalline structure, and
the second Ru-containing layer includes columnar crystalline structure continuously formed in the thickness direction to the crystal that is the nucleus and is formed with a dome-shaped convex part at the top thereof.

3. The magnetic recording medium according to claim 1,
wherein a second diffusion prevention layer made of a material having a melting point of 1500° C. or higher and 4215° C. or lower and formed by a covalent bond or an ionic bond and prevents the thermal diffusion of the Ru atoms of the Ru-containing layer is provided on the Ru-containing layer on the side of the non-magnetic substrate.

4. The magnetic recording medium according to claim 2,
wherein an intermediate diffusion prevention layer made of a material having a melting point of 1500° C. or higher and 4215° C. or lower and formed by a covalent bond or an ionic bond and prevents the thermal diffusion of the Ru atoms of the Ru-containing layer is provided between the first Ru-containing layer and the second Ru-containing layer.

5. The magnetic recording medium according to claim 1,
wherein the diffusion prevention layer includes any one selected from a group including AlN, SiO₂, MgO, Ta₂O₅, Cr₂O₃ and ZrO₂.

6. The magnetic recording medium according to claim 1,
wherein a soft magnetic underlayer is provided on the orientation control layer on the side of the non-magnetic substrate.

7. The magnetic recording medium according to claim 1,
wherein the vertical magnetic layer includes an alloy having an L1₀ crystalline structure as a main component.

8. A method for manufacturing a magnetic recording medium, comprising:
an orientation control layer forming process of forming an orientation control layer that controls orientation of a layer immediately above on a non-magnetic substrate; and
a vertical magnetic layer forming process of forming, on the non-magnetic substrate, a vertical magnetic layer in which an easy axis of magnetization is mainly vertically oriented with respect to the non-magnetic substrate,
wherein the orientation control layer forming process includes a process of forming an Ru-containing layer containing Ru or Ru alloy, and a process of forming, on the Ru-containing layer, a diffusion prevention layer made of a material having a melting point of 1500° C. or higher and 4215° C. or lower and formed by a covalent bond or an ionic bond and prevents thermal diffusion of Ru atoms of the Ru-containing layer, and
the vertical magnetic layer forming process includes a heating process of heating the non-magnetic substrate at 300° C. to 700° C. immediately before the start of formation of the vertical magnetic layer and/or during the formation to form the vertical magnetic layer that has a crystalline structure of crystal grains continuously formed from the Ru-containing layer with the diffusion prevention layer interposed therebetween and includes a columnar crystal continuously formed in a thickness direction together with the crystal grains.

9. The method for manufacturing a magnetic recording medium according to claim 8,
wherein, in the process of forming the diffusion prevention layer, the diffusion prevention layer that includes any one selected from a group including AlN, SiO₂, MgO, Ta₂O₅, Cr₂O₃ and ZrO₂ is formed.

10. The method for manufacturing a magnetic recording medium according to claim 8,
wherein a process of forming a soft magnetic underlayer on the non-magnetic substrate is performed before the orientation control layer forming process.

11. A magnetic recording and reproducing device comprising:
the magnetic recording medium according to claim 1;
a medium drive unit that drives the magnetic recording medium in a recording direction;
a magnetic head that performs a recording operation and a reproducing operation with respect to the magnetic recording medium;
a head drive unit that relatively moves the magnetic head with respect to the magnetic recording medium; and
a recording and reproducing signal-processing system that performs input of a signal to the magnetic head and reproduction of an output signal from the magnetic head.

12. The magnetic recording and reproducing device according to claim 11,
wherein the magnetic head includes a laser generating unit that heats the magnetic recording medium, a wave guide that guides laser light generated from the laser generating unit to a tip portion thereof, and a near-field generating element provided at the tip portion.
